(19) United States
(12) Patent Application Publication
(10) Pub. No.: US 2010/0012141 A1
(43) Pub. Date: Jan. 21, 2010

(54) Hair treatment dispensing applicator and comb attachment

(76) Inventor: Sallie Beatrice Middlebrook, Missouri City;, TX (US)

Correspondence Address: Sallie Middlebrook, 3914 Crow Valley Drive, Missouri City, TX, 77459, US

(21) Appl. No.: 12/460,220

(22) Filed: Jul. 15, 2009

Related U.S. Application Data
(60) Provisional application No. 61/081,639, filed on Jul. 17, 2008.

(51) Int. Cl. A61Q 5/00; A45D 24/22; A45D 24/00

(52) U.S. Cl. 132/202; 132/112; 132/163

(57) ABSTRACT

The invention is a process and a dispenser container and comb attachment to be used for applying cosmetic chemical hair straightening cream in order to straighten out the curl of naturally curly or kinky human hair. It combines advantages of dispensers of thicker liquids with advantages of dispensers and combs used to apply thinner liquids, such as hair color. It uses a comb attachment and easy to grip handle similar to those that come with some hair dryers, allowing users to comb and smooth the hair as the chemical straightens the curl. The invention provides an easy way to load the container with the hair straightening cream using a detachable comb unit that also serves as a removable cap. Removing the comb opens the container so that the chemical cream can be loaded. Attaching the comb allows the user to dispense and apply the cream to the hair.

### CROSS-REFERENCE TO RELATED APPLICATIONS

Not Applicable

### STATEMENT REGARDING FEDERALLY SPONSORED RESEARCH/DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The proposed patent relates to an invention and a process that is a dispensing container and comb attachment to be used in applying lye and non-lye based hair straightening cream (called relaxers), a viscous and caustic substance, to naturally curled or kinky hair, for the purpose of straightening the natural curl. The invention relates to a movable product elevator means residing within the dispensing container for the purpose of dispensing the product, and a comb attachment sub-assembly that is used to smooth and straighten the hair after the relaxer cream has been applied using the dispenser container.

There are combs that are used to apply watery liquid hair products to the hair. U.S. Pat. No. 7,331,352 B2; U.S. Pat. No. 5,289,833; U.S. Pat. No. 6,112,751, and U.S. Pat. No. 3,961,635 provide examples of prior art proposals for combs that dispense liquids. In these designs, a comb apparatus is attached to a bottle or some other type of container. In many instances of inventions such as this, the combs may have hollow roots that connect with hollow teeth containing small apertures at the end. Liquid is squeezed from the bottle and expelled when pressure is applied. With such bottles and combs, the liquid to be expelled is of a watery consistency to be expelled easily from the tiny apertures when pressure is applied to the bottle.

U.S. Pat. No. 5,848,598 refers to prior art proposals for an invention that is a container for use in storing and dispensing hair treatments such as lye and non lye-based hair straightening cream. While the intended purpose is the same, my invention is markedly different in method of assembly and method of use. This invention requires the invention to be loaded with the relaxer chemical cream during the manufacturing process, and it is intended for use by cosmetologists/beauticians, and not by those who apply such products to their own hair at home. While my invention does not require it, it could definitely be used to pre-load the chemical cream product during the manufacturing process of the relaxer cream. However, my invention is made primarily for the home user, but can also be used by cosmetologists/beauticians.

There are also dispensers that allow more precision and control when applying viscous substances, such as stick or gel deodorant, to underarm areas. For example, U.S. Pat. No. 4,950,094 exemplifies prior art proposals for containers created for the purpose of dispensing a viscous cosmetic product such as a gel antiperspirant. Dispenser containers such as this one comprise a one-piece body member formed of elongated tubular sidewalls, a top wall, and a bottom wall section. The one-piece body member is open at the top and is substantially oval in cross-section. The bottom wall section of the body members contain an internally placed elevator means that is vertically moved by turning a dial. As the dial is turned, the elevator lifts, which causes the product to be expelled through holes in the top of the container.

There are hand-held hair dryers made with comb attachments, such as U.S. Pat. No. 4,538,362. With devices such as this one, the combs are attached using rail-like structures allowing the user to slide the comb on or off of the hair dryer as needed.

Presently, chemical hair straightening creams are normally applied to the hair by hand, with the use of protective plastic gloves, for the purpose of permanently straightening naturally curled or kinky hair. Following is a description of how the present application process works.

Applying the product by hand is a messy, drippy and inconvenient process that does not allow for any kind of precision in the way the chemical is applied to the hair. First, the person applying the product usually covers their hands using a pair of thin, plastic gloves that usually come packaged with the relaxer cream product. Gloves are needed because if the chemical cream comes in contact with skin for a prolonged period of time, it can cause skin irritation and possibly chemical burns. Often, the gloves that come packaged with the relaxer cream product will tear during use because they are very thin and prone to tearing either while the user is putting them on, or during the relaxer cream application process. When the gloves tear, the user's hands can be left exposed to potentially harmful chemicals.

Even if the gloves remain intact with no tearing, the application process is still quite messy and imprecise, and the chemical cream sometimes splashes or drips onto the skin. As the user scoops the chemical cream from its container using one gloved hand, the cream often drips as it is being transported from the cream container to the user's hair. As it drips, it can spill on countertops, and/or on the skin and clothing of the person whose hair is being relaxed, or on the person who is applying the cream (if two people are involved in the hair relaxing process).

In beauty shops, when chemical cream hair relaxers are being applied to the hair, the person applying it sometimes will place a plastic poncho over the clothing of the person whose hair is being treated in order to catch spills and to shield and protect skin and clothing. However, chemical relaxer products are widely available over-the-counter and millions of women (mostly African American and other women of African heritage all around the world) apply these products to their own hair in the privacy of their own homes, and most of the time, no poncho is used during the application process. One reason the poncho is not usually used during the in-home application process may be that this would simply add another step to an already dreaded, time-consuming, imprecise, laborious and messy application process.

In addition, applying the relaxer by hand does not allow the user a good way to selectively control the amount of chemical relaxer cream product that is scooped up and/or the amount that is applied to the hair. What is needed is an affordable, convenient, easy to use application system that will help to minimize drips and spills while allowing the in-home user as well as professional beauticians to exert more control over the way the relaxer product is applied. Even though gloves will still be needed for added protection in applying the product, the proposed invention and/or manufacturing process will cause there to be a lot less contact between the hands and the chemical relaxer cream. Therefore, this invention will help to minimize drips and spillage, making the application process less messy, less laborious, less time-consuming, less dreaded, and allowing more precision and control in applying the relaxer cream to the hair.

### SUMMARY OF THE INVENTION

The objective of the present invention is to provide a chemical cream hair product dispenser that combines the advantages of dispensers of thicker liquids, such as gel deodorant dispensers, with the advantages of bottle-type dispensers with comb attachments that are used to dispense thinner liquids, such as hair color, and with the advantage of hand-held blow dryers that give the user a way to grip the dispenser to exert control and precision over the relaxer application process. The present invention uses a comb attachment unit similar to those that come with some hair dryers, allowing the user to comb and smooth the hair as the chemical is straightening the curl. The comb attachment unit has a plurality of apertures allowing the product to be extruded from the container when the threaded shaft wheel/knob is turned moving the elevator means toward the comb attachment unit. The invention has a handle to make it easy to grip and hold. It also provides an easy way to load the container with the chemical relaxer cream by using a detachable comb unit that also serves as a sort of removable cap. Removing the comb opens the container so that the cream relaxer can be loaded onto the elevator means that is residing in the dispenser container body.

It is another objective of the invention to provide a reliable and easy-to-use method of applying chemical relaxer cream that will allow more precision in applying the cream to the hair, and that will allow a cleaner application process, with less mess and spillage of cream. Finally, it an objective of this invention to provide a reliable comb applicator that is uncomplicated in its construction, that is effective in its use, and that is easy and economical to produce and to use.

The invention is a dispensing applicator and comb, in one product. The comb is part of the container itself, but it is detachable. The comb can be used to help section the hair, and to help smooth and straighten out the natural curl as the chemical cream is being applied to the hair. The front end of the underside of the container is where the comb-type structure is attached. The teeth of the comb protrude from the center of the comb attachment. In between the teeth are apertures that are communicable with the reservoir of cream liquid that is to be applied to the hair. The sturdy plastic container body itself is a reservoir tank that holds the entire contents of one application of relaxer cream (the dispenser will hold at least 5.5 oz of cream). The rounded oval handle is made of denser plastic, and it is shaped to be easy to grip and hold. The invention is small enough and lightweight enough to allow the user, using one hand, to grip the handle while also using a thumb or finger to turn the threaded shaft wheel/knob that is situated on the top of the dispenser container body, well within reach of the thumb. When turned, the threaded shaft wheel/knob moves an elevator means, forcing the relaxer cream to be expelled from the dispenser and through the apertures in its base. Each aperture is placed on the bottom front of the comb between the teeth of the comb structure, with each opening alternating with placement of teeth. The apertures/holes are small enough that the thickness of the relaxer cream does not allow it to leak out easily when the elevator means is not being advanced.

Since current “no-lye” cream hair relaxers (which are currently the most popular and best-selling among these types of products) must be mixed with activator chemical before they are applied to the hair, the user will still need to mix the product. The mixing, however, could take place prior to placing the relaxer cream into the dispenser container, or it could take place after the user places the cream into the dispenser container since the elevator means will be fully retracted prior to use of the invention, providing a solid and flat surface for mixing the product. A plastic or wooden scoop or spoon (usually provided along with the cream relaxer product) is now used to scoop and scrape the cream relaxer product from its original container, and this same method can be used to load the cream into the dispenser container. At-home users of cream hair relaxer products are accustomed to scooping and mixing this product, and will not see the loading step as a hindrance or as cumbersome. Since scooping the product into the applicator will be a simple process, it will still allow the user to see the dispenser applicator and comb as a much cleaner and more precise way to apply the cream relaxer product.

It is possible for the present invention to be used to pre-load the chemical hair relaxer cream after it is manufactured but before it is packaged. Currently, the relaxer cream product is loaded into round plastic tubs. Since the present invention is also made of plastic, it would be just as easy to pre-load the chemical into the dispenser container, and to place a thin plastic film or other type of closure on the opening of the dispenser container to keep the product contained until it is purchased and ready for use by end user. The end user would simply remove the original closure, and would snap on the comb attachment unit, and the dispenser applicator would be ready for use. If the dispenser container were pre-loaded with the hair relaxer cream, the loading process would be eliminated for the end user.

An alternative embodiment could have a trigger pumping means (similar to those used with water guns) associated with the dispenser applicator. The trigger could be positioned so that the forefinger of a hand holding the bottle may be used to depress the trigger. Also alternatively, the plastic container could be formed using a squeezable plastic that may allow the cream to be dispensed selectively without use of the elevator means mechanism, and without the use of the handle. There could also be alternative ways to load the product into the dispenser container, without use of a detachable comb. The comb could be permanently attached to the dispenser container, and there could be an opening on the side of the container, with a snap-on/off, or screw on/off structure creating an opening for loading the container.

### BRIEF DESCRIPTION OF THE SEVERAL VIEWS OF THE DRAWING

FIG. 1: is a perspective view of the invention in use. It depicts how the invention is used to apply cream to the hair while also using the comb attachment to smooth and straighten the hair.

FIG. 2: is a side elevation view of the invention. It illustrates the flattened top of the ample-sized threaded shaft knob which will allow the user to place the invention down on a flat surface in order to load the product.

FIG. 3: is an exploded side elevation view of the invention. It provides a view of the comb attachment in the released position from the dispensing container body.

FIG. 4: is a side elevation view showing how the reservoir of the invention is filled.

FIG. 5: is side elevation view of the invention with parts broken away. It depicts the preferred embodiment of the invention, illustrating the dispenser container body having a bottom portion with an opening, a top portion with a wall section and center opening through which extends a portion of the bushing which is fixed to the threaded shaft knob.

FIG. 6: is a detail top plan view of the internal portion of the comb attachment unit of the invention, illustrating the plurality of apertures formed of a size allowing the cream relaxer product to flow through.

FIG. 7: is a detail plan view of internal and external components of the elevator means.

FIG. 8: is a detail top plan view of the platform of the elevator means.

FIG. 9: is a detail plan view of the threaded shaft shaft with bushing and turning knob fixed to the shaft shaft.

FIG. 10: is a detail top plan view of the dispenser container and accommodations for threaded shaft bushing and hand wheel knob.

### DETAILED DESCRIPTION OF THE INVENTION

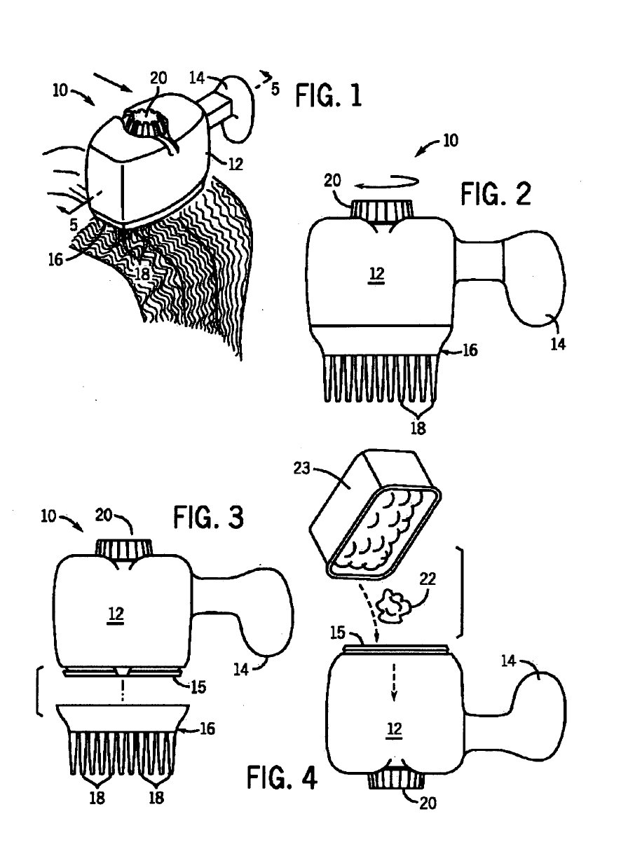

FIG. 1: is a perspective view of the invention in use. By way of example in the illustrated embodiment, the invention dispenser container body reservoir is in the form of an oval barrel having a longitudinal axis 5. The dispenser applicator with comb unit attached 10 allows the user to turn the knob 20 to extrude and apply relaxer cream from the dispenser body 12 to the hair while holding the invention by the handle 14 while using the comb unit 16 to extrude and apply the relaxer cream and its protruding teeth 18 to smooth and straighten sections of hair.

FIG. 2: is a side elevation view of the dispenser applicator with comb unit attached 10. It illustrates the flattened top of the ample-sized threaded shaft knob 20 which will allow the user to place the invention down on a flat surface in order to load the product. It also depicts the proximity of the easy-to-grip handle to the threaded shaft knob 20, allowing the user ease of use in applying relaxer cream from the dispenser body 12 to sections of hair. This drawing also depicts a preferred embodiment of the comb attachment unit 16 as is appears when attached to the dispenser container body.

FIG. 3: is an exploded side elevation view of the dispenser applicator and comb unit 10 with comb detached. It also depicts the threaded shaft knob 20 and provides a view of the comb attachment unit 16 in the released position from the dispensing container body, as well as a view of the comb teeth 18 protruding from the underside of the comb attachment unit 10.

FIG. 4: is a side elevation view depicting the flat threaded shaft knob 20 placed on a flat surface illustrating how the reservoir of the invention is filled by scooping relaxer cream 22 from the relaxer cream tub 23 and placing it inside the dispenser container body 12. It also depicts the top portion of the opening and outer ring of steps 15 of the dispenser container body.

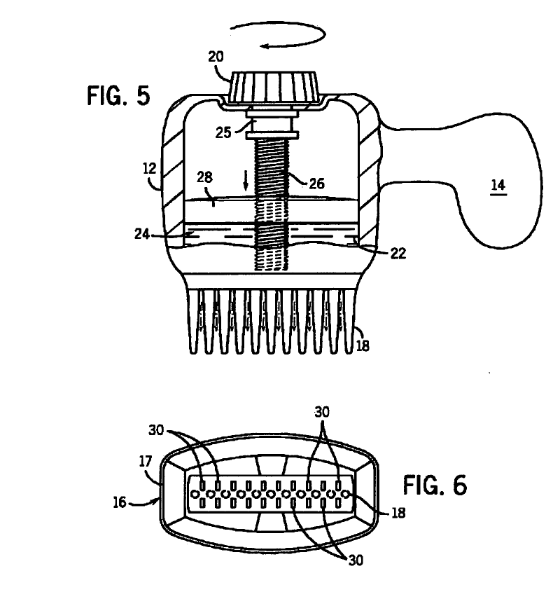

FIG. 5: is side elevation view of the invention with parts broken away depicting the preferred embodiment of the invention, and illustrating the dispenser container body 12 and handle 14. It illustrates that the dispenser body has a bottom portion with an opening that is also a reservoir 24 that holds the relaxer cream. It also illustrates the top portion of the dispenser body and its top wall section and center opening through which extends a portion of the bushing 25 which is fixed to the threaded shaft knob 20. This view also illustrates the elevator means 28 that acts as a piston, and that resides within the dispenser container body and that it is fixed to and is in threaded engagement with the threaded shaft 26. Finally, this view depicts how the relaxer cream 22 is contained in the dispenser in communication with the elevator means and how it is advanced toward the comb attachment apertures where the cream is expelled, and toward the comb protruding plurality of teeth 18 used to smooth and straighten the hair once the cream is applied.

FIG. 6: is a detail plan view of the internal portion of the comb attachment unit of the invention illustrating the plurality of aperture slots 30 formed of a size allowing the cream relaxer product to flow through. The apertures are spaced in intervals alternating with placement of the comb's teeth 18 which protrude from the external underside of the bottom portion of the comb attachment. It also illustrates the friction snap assembly 17 of the comb attachment unit 16.

FIG. 7: is a detail plan view of internal and external components of the elevator means 28. It illustrates the outer edges of the elevator means which forms a skirting 34 that substantially conforms to the side wall portions of the dispenser container body, sealing against the internal surface of the container and preventing leakage of product into the area underneath the elevator means. It also depicts the thread 33 of the opening in the center of the elevator means, illustrating both the bottom 35 of the opening and top 32 of the opening which is positioned for receipt of the threaded shaft 26. It also illustrates a side view of the top of the elevator means 31 and the bottom edge 36 of the elevator means.

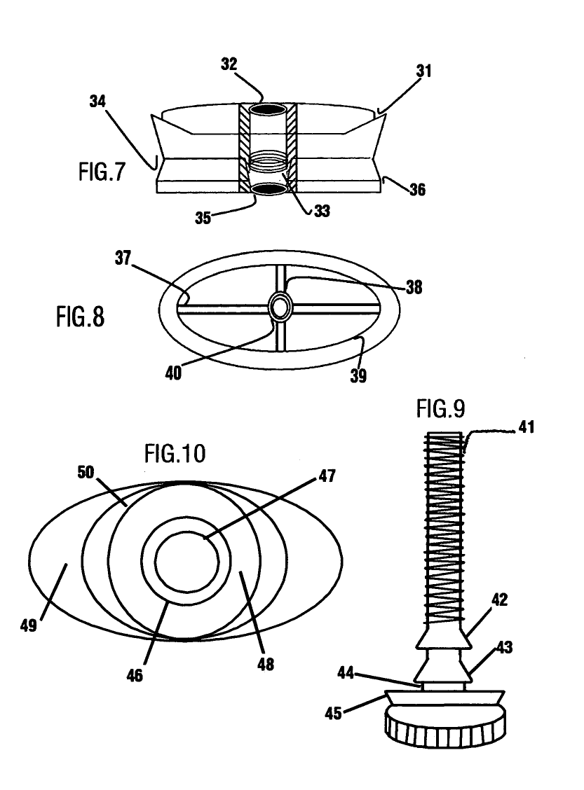

FIG. 8: is a detail top plan view of the platform of the elevator means 28. It shows a plurality of spaced apart stabilizing ribs 37 and 38 radiating from and converging to a common center 40 of the elevator means and along the periphery of the elevator means towards the edges 39 of the elevator means.

FIG. 9: is a detail plan view of the threaded shaft 41 with bushing and a turning knob 45 fixed to the threaded shaft. It illustrates the small threaded shaft stop plate 42 that is fixed to the threaded shaft to stop the elevator means at the top of the dispenser container body. It also illustrates the larger plate 43 fixed to the top portion of the bushing 44 that snaps into the center opening of the dispenser container connecting and supporting said threaded shaft and the threaded shaft knob.

FIG. 10: is a detail top plan view of the dispenser container and its recessed portion of top section 49 and wall 50. It illustrates the invention's accommodations for fitting of the threaded shaft knob 20 and the bushing plate 45 that snaps into the rounded opening 46 allowing the knob to rest in the recessed top portion 48 of the dispenser body top wall section. It also depicts the center opening in the top wall section of the dispenser 46 and its skirt 47 that helps to hold in place the threaded shaft bushing as it sits in the center of the top wall section of the dispenser container body.

In summary, by this invention, a process and a dispenser for extruding and applying a cosmetic chemical hair straightening cream is provided allowing ease of use, and more precision and control with regard to the chemical relaxer application process. This invention affords less mess and spillage that is normally associated with use of relaxers to straighten naturally curly or kinky hair, and fewer opportunities for burns to skin that is associated with spills of relaxer. The invention affords a reliable comb applicator that is uncomplicated in its construction, and that provides for more effective and more efficient use of the chemical relaxer cream and the chemical hair straightening process, primarily for the at-home user, but also for professional beauticians/cosmetologists.

As my invention I claim:

1. A chemical cream dispensing applicator and comb, and method for applying or storing a chemical cream hair product comprising:
a dispenser body having a chemical cream container body;
a dispenser container body having a detachable and re-attachable comb attachment unit with apertures and a plurality of protruding teeth;
a dispenser container body having a bottom portion with an opening, side portions, and a top portion with a wall section having a rounded and threaded center opening;
a dispenser container body having a handle connected at one end;
a dispenser container body having a threaded shaft inside said dispenser container body;
a dispenser container body having a bottom portion with an opening, a top portion with a wall section having said rounded and threaded center opening through which extends a portion of bushing which is fixed to said threaded shaft knob, wherein said rounded center opening in top portion wall section is sized to engage a portion of said bushing which is fixed to threaded shaft knob, and wherein said threaded shaft knob is a hand-turned wheel;
a dispenser container body having an advanceable and retractable elevator means received within said container and is fixed to, and in threaded engagement with, said screw means whereby extrudable material contained in said container and in contact with said elevator means is advanced toward said comb attachment apertures and expelled through said apertures as said knob is turned to advance said elevator means; wherein said elevator stop member of said screw means engages said elevator means for limiting position of said elevator means relative to said screw means;
a dispenser container body wherein said elevator means within said container body is movable within said container body by rotating the threaded shaft knob and selectively dispensing a portion of a chemical cream hair product that is placed or stored inside said elevator means;
a dispenser container body having a bottom opening fitted for friction snap mating with a comb attachment unit.

2. A chemical cream dispensing container and comb attachment according to claim 1, wherein said dispenser container body has a comb attachment unit for dispensing chemical relaxer cream and for parting, smoothing and straightening sections of hair after applying the chemical product.

3. A chemical cream dispensing container and comb attachment according to claim 1, wherein the bottom opening of said dispenser container body has an outer ring of steps; said outer ring of steps on said bottom opening circumscribes and holds in place, in the closed position, said comb attachment unit; a straight downward force and twisting of said comb attachment unit in either direction causes said friction snap closure to be released from the dispenser container; said comb attachment unit may be removed by twisting to the left or right, facilitating the unsnapping thereof from said dispenser container; the mating of said comb attachment unit with said dispenser container requires a straight downward force to engage the steps and snap the comb attachment unit over said dispenser container outer ring of steps to achieve closure.

4. A chemical cream dispensing container and comb attachment according to claim 1, wherein said dispenser container houses a threaded shaft having a knob that is selectively rotated in order to reciprocally move the advanceable and retractable elevator means that is both a means for holding in place and a means for pushing the chemical relaxer cream out of said dispenser container body and onto sections of hair.

5. A chemical cream dispensing container and comb attachment according to claim 4 wherein said elevator means retained inside the container body operates like a piston, moving up and down said threaded shaft between a retracted position contiguous to said top wall portion of the container applicator, and a fully extended position near said bottom opening of the dispenser container; when the comb attachment unit is attached to the dispenser container body, and when said knob is turned to advance said elevator means, the chemical cream hair product is extruded through said apertures in said top portion of said comb attachment unit, providing a means for the dispensation of the hair product.

6. A chemical cream dispensing container and comb attachment according to claim 1 wherein said dispenser container body has top and bottom and side wall portions, with said internal top and side wall portions constructed for the purpose of holding securely in place said elevator means that is retained inside said dispenser container body; one external side wall portion having a handle connected to said dispenser container body, said handle allowing the user to grip and hold said dispenser container body and comb attachment unit while dispersing chemical relaxer cream out of said dispenser container body and onto sections of hair.

7. A chemical cream dispensing container and comb attachment according to claim 5 wherein said threaded shaft has a knob extending from the center of the top wall portion of said dispenser container body, with said threaded shaft being disposed within said dispenser container body having a bushing portion connecting and supporting said threaded shaft and said threaded shaft connecting said threaded shaft knob which extends from opening in the center of said top wall portion; said threaded shaft knob is formed connected to said bushing and extends through opening in center of said top wall portion.

8. A chemical cream dispensing container and comb attachment according to claim 6 wherein said elevator means has outer edges forming a skirt which substantially conforms to said side wall portions, sealing against the internal surface of the container body and preventing leakage of product into the area underneath the means; said elevator means having a threaded opening formed at the center thereof for receipt of said threaded shaft that is formed to be connected with said bushing portion of threaded shaft.

9. Also claimed is the method of the chemical cream dispensing system of claim 1, wherein said elevator means includes a plurality of spaced apart stabilizing ribs radiating from and converging to a common center of said elevator means and along the periphery of said elevator means, extending from the sides to an inner region of the top portion of said elevator means.

10. The elevator means of claim 8, having a plurality of radially directed stabilizing ribs being arranged in a spaced apart manner on the bottom portion of the elevator means along the periphery of the base, further including a continuous hollow threaded center; the center being configured for threaded engagement with a threaded spindle for selectively and reciprocally moving the elevator means within said dispenser container body for dispensing a cream product in one mode of operation with the elevator means within the container, while being retractable in another mode of operation.

11. A chemical cream dispensing container and comb attachment according to claim 1 wherein said dispenser container has a handle attached to one external side wall of the body of the dispenser; said handle allowing the user to grip and hold the dispenser applicator in much the same way that a comb or a hand-held hair dryer is gripped and held, and wherein said dispenser container handle is constructed to be easily gripped and to provide close proximity to said threaded shaft knob; said container handle is constructed so that use can easily hold said handle while using thumb or forefinger to turn said threaded shaft knob to move said elevator means.

12. A chemical cream dispensing container and comb attachment according to claim 9 wherein said comb attachment sub-assembly unit has a top portion and a bottom portion; the bottom portion of said comb attachment has a plurality of apertures formed therein of a size allowing the cream relaxer product to flow through said apertures.

13. A chemical cream dispensing container and comb attachment according to claim 12 wherein said comb attachment sub-assembly has a bottom portion with a plurality of generally parallel protruding teeth for sectioning and smoothing hair while applying the cream product to the hair; the bottom portion of the comb attachment unit having apertures spaced in intervals alternating with placement of said teeth.

14. A chemical cream dispensing container and comb attachment according to claim 12 wherein said comb attachment unit has a friction snap means of connecting to said container body, with a downward force twisting motion to the left or right, away from said container body, said comb attachment is released from said container body allowing the opening and filling of said container body with the chemical cream relaxer product; a downward force twisting motion towards said container body connects said comb attachment unit with said container for the purpose of containing chemical cream relaxer product prior to application to hair.

15. The dispensing system of claim 8, wherein a pair of opposed semicircular chambers are disposed inside the sidewall of the inner partition of said elevator means; wherein said elevator means is positioned within the body of the container at the top end, with the elevator including:
a threaded central hub engaged with the threaded shaft, the threaded central hub sealed against the spindle of the threaded shaft to prevent the escape of product when the elevator means is advanced from its retracted position at the closed top end of the container body;
a top wall; and
a chemical cream relaxer reservoir having inside walls conforming to a radius swept by said elevator means as the threaded shaft knob is turned to advance the elevator means, pushing chemical cream toward said comb attachment unit apertures; wherein chemical cream relaxer is directed to said apertures in said comb attachment unit when said threaded shaft knob is turned, causing said elevator means to push chemical cream relaxer product through said comb attachment unit apertures and onto sections of hair; the chemical cream reservoir.

16. The apparatus of claim 1 wherein the system is made of durable and sturdy, yet flexible plastic; wherein it should be also recognized that various other forms including different shapes and sizes of elevator means to conform with the different forms and shapes of the container, may be utilized within the spirit and the scope of my invention.
